(19) United States
(12) Patent Application Publication
(10) Pub. No.: US 2020/0278027 A1
(43) Pub. Date: Sep. 3, 2020

(54) WATER-BLOCKING STRIP FOR SURFACE FITTING INSTALLATION

(71) Applicant: Tie Li, Shenzhen (CN)

(72) Inventor: Tie Li, Shenzhen (CN)

(21) Appl. No.: 16/876,116

(22) Filed: May 18, 2020

Related U.S. Application Data
(63) Continuation of application No. PCT/CN2019/076025, filed on Feb. 25, 2019.

(30) Foreign Application Priority Data
Oct. 12, 2018 (CN) 201811188142.X

(51) Int. Cl. F16J 15/10; E04B 1/68

(52) U.S. Cl. CPC F16J 15/104; E04B 1/6813

(57) ABSTRACT

A water-blocking strip for surface fitting installation includes a strip-shaped main body (1); and closed protrusions (2) continuously distributed on a surface of the strip-shaped main body (1), such that installation is tightly fitted and water-blocking. The design of the closed protrusions continuously distributed on the surface of the water-blocking strip is such that even using a small force, an object to be installed can be caused to be closely fitted to a wall surface and no gap is prone to be formed therebetween, achieving a better waterproofing and water-blocking effect.

### CROSS REFERENCE TO RELATED APPLICATIONS

The present application is a continuation application of PCT/CN2019/076025, filed on Feb. 25, 2019 which claims the priority of Chinese patent application No. 201811188142.X filed on Oct. 12, 2018, the entire contents of which are incorporated herein by reference.

### TECHNICAL FIELD

The present application relates to the technical field of waterproof and water-blocking, in particular to a water-blocking strip for surface fitting installation.

### BACKGROUND TECHNOLOGY

In the existing water-blocking strip for installation, the surface is a complete plane or a plane attached with an adhesive. For example, when installing some components on an outdoor wall, a water-blocking strip is usually placed between the object to be installed and the wall, so that there is no gap therebetween, achieving a waterproof and water-blocking effect. However, under most circumstances, the surface of the outdoor wall is not completely smooth. On the one hand, during the installation process, a large force may be required to make the object to be installed, the water-blocking strip and the surface of the wall to be closely fitted, such as by tightly fastening with a fastener like a screw. On the other hand, even if a large force is applied during installation, gap still exists for water to flow between the water-blocking strip and the installed object or between the water-blocking strip and the wall surface, which leads to a poor waterproofing effect.

### SUMMARY

A technical problem that needs to be solved in the present application is the waterproof and water-blocking problem during surface fitting installation on a surface such as a wall.

In order to solve the above technical problem, the present application discloses a water-blocking strip for surface fitting installation. The water-blocking strip includes a strip-shaped main body, and closed protrusions continuously distributed on a surface of the strip-shaped main body, so that installation is tightly fitted and water-blocking.

Further, each of the closed protrusions has a circular, polygonal or irregular closed shape, all the closed protrusions are closely arranged, and adjacent closed protrusions are in contact with each other or sharing a common edge.

Further, the closed protrusions themselves have lines with a line width of 0.3-10 mm, and a short cross-section of the lines is not pointed. The protruded closed protrusions have a protruded height that is 10-300% of the line width.

Further, the closed protrusions are distributed at a certain angle on the surface of the, and the angle is not less than 15 degrees and not more than 165 degrees.

Further, the closed protrusions are vertically distributed on the surface of the strip-shaped main body.

Further, the material of the water-blocking strip itself is an elastic material.

Further, the material of the water-blocking strip itself is EVA, rubber, silicone, polyurethane or foam.

Further, the closed protrusions are distributed on one surface of the strip-shaped main body.

Further, the closed protrusions are distributed on another surface of the strip-shaped main body.

Further, another surface of the strip-shaped main body is provided with an adhesive layer and forms a pasting surface.

The present application discloses a water-blocking strip for surface fitting installation. The water-blocking strip includes a strip-shaped main body, and closed protrusions continuously distributed on a surface of the strip-shaped main body, so that the installation is tightly fitted and water-blocking. When installing an object on a surface such as a wall, a water-blocking strip can be placed between the object and the wall. The design of the closed protrusions continuously distributed on the surface of the water-blocking strip is such that even a small force is applied, an object to be installed can be closely fitted to a wall surface and no gap is prone to be formed therebetween, thereby achieving a better waterproofing and water-blocking effect.

### BRIEF DESCRIPTION OF THE DRAWINGS

The specific structure of the present application is described in detail below with reference to the accompanying drawings.

FIG. 1 is a top view of a water-blocking strip;

FIG. 2 is a schematic diagram of the closed protrusions of a water-blocking strip;

FIG. 3 is a schematic diagram of another closed protrusions of the present application;

FIG. 4 is a side view of a water-blocking strip;

FIG. 5 is another side view of a water-blocking strip;

FIG. 6 is yet another side view of a water-blocking strip.

1 strip-shaped main body, 2 closed protrusions, 3 adhesive layer

### DESCRIPTION OF THE EMBODIMENTS

In order to explain in detail the technical content, structural features, achieved objectives and effects of the present application, the following will be described in detail in conjunction with the embodiments and accompanying drawings.

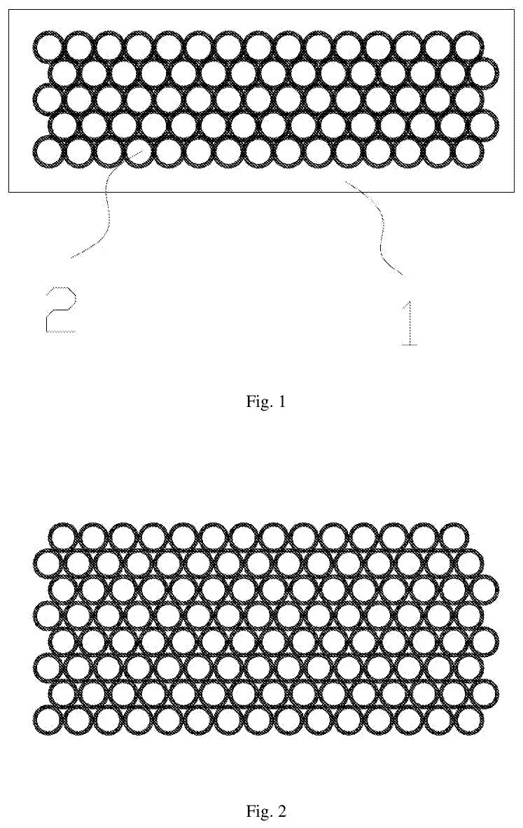

Referring to FIG. 1, an embodiment discloses a water-blocking strip for surface fitting installation, including a strip-shaped main body 1; closed protrusions 2 continuously distributed on a surface of the strip-shaped main body 1, such that installation is tightly fitted and water-blocking. In the prior art, a water-blocking strip is usually deformed by external pressure, so that there is no gap between the installed object, the water-blocking strip and the wall surface, thereby achieving a waterproofing effect. In the present embodiment, the conventional planar water-blocking strip is designed with closed protrusions 2 continuously distributed on a surface of the water-blocking strip. On the one hand, the closed protrusions 2 are more likely to deform comparing to the entirety of water-blocking strip in the prior art when an external force is applied. In other words, during installation, the closed protrusions 2 may be deformed under a smaller external force to make the installed object, the water-blocking strip and the wall surface closely fitted without a gap therebetween. On the other hand, due to the continuous distribution and closure of the closed protrusions 2, water from the environment cannot enter once being installed, and even if the outermost closed protrusions 2 are partially damaged, the overall waterproofing effect of the water-blocking strip will not be affected.

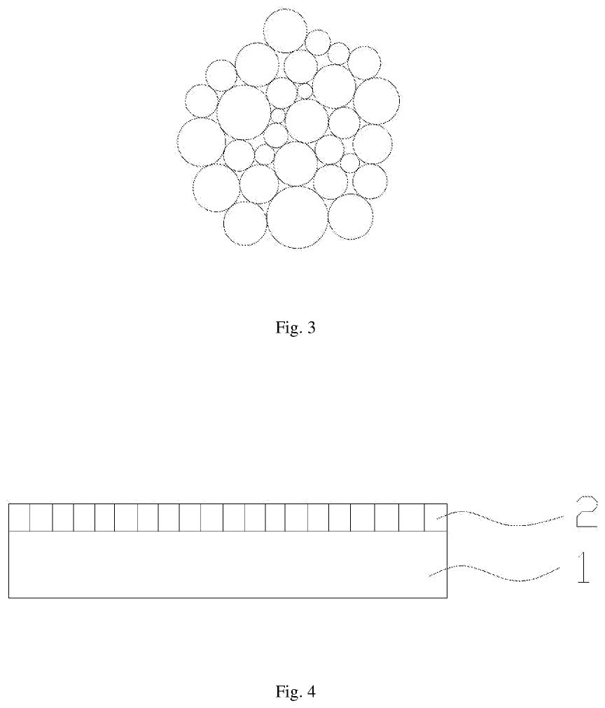

Now referring to FIGS. 2 and 3, each of the closed protrusions 2 has a circular, polygonal or irregular closed shape, all the closed protrusions 2 are closely arranged, and adjacent closed protrusions 2 are in contact with each other or sharing a common edge. The size of each of the closed protrusions 2 may be the same or different, as long as it is continuous and closed.

Preferably, the closed protrusions 2 themselves have lines with a line width of 0.3-10 mm, and the short cross-section of the lines is not pointed. The protruded closed protrusions 2 have a height that is 10-300% of the line width.

Preferably, the closed protrusions 2 are distributed at a certain angle on the surface of the strip-shaped main body 1, and the angle is not less than 15 degrees and not more than 165 degrees. Of course, it may also be preferably as shown in FIGS. 4, 5 and 6, that the closed protrusions 2 are vertically distributed on the surface of the strip-shaped main body 1. This vertical distribution leads to an easier manufacturing of the water-blocking strip.

Preferably, the material of the water-blocking strip is an elastic material, preferably an elastic material such as EVA, rubber, silicone, polyurethane or foam.

Referring to FIG. 4, in a specific embodiment, the closed protrusions 2 are distributed on one surface of the strip-shaped main body 1, and another surface may be a smooth surface without excessive treatment.

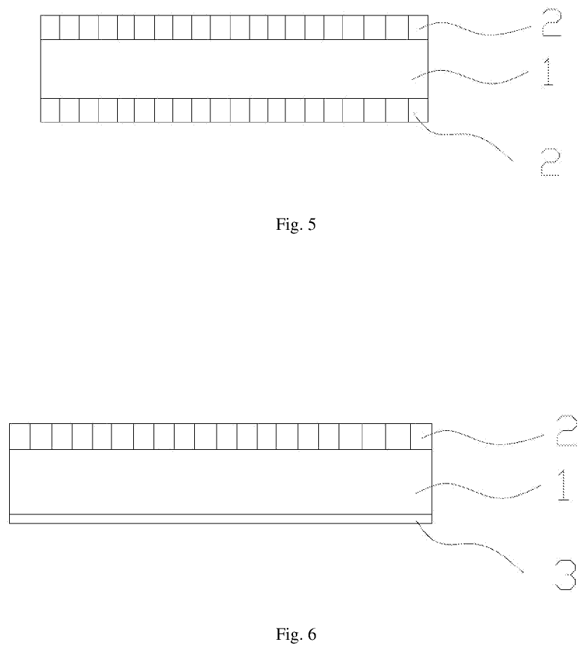

Referring to FIG. 5, in a specific embodiment, the closed protrusions 2 are distributed on one surface of the strip-shaped main body 1, and the closed protrusions 2 are also distributed on another surface of the strip-shaped main body 1, i.e. both surfaces of the strip-shaped main body 1 are designed with the closed protrusions 2.

Referring to FIG. 6, in a specific embodiment, closed protrusions 2 are distributed on one surface of the strip-shaped main body 1, and another surface of the strip-shaped main body 1 is provided with an adhesive layer 3, which forms a pasting surface for bonding.

A water-blocking strip for surface sitting installation is disclosed in the present application. The water-blocking strip includes a strip-shaped main body. Closed protrusions are continuously distributed on a surface of the strip-shaped main body, such that installation is tightly fitted and water-blocking. When installing an object on a surface such as a wall, a water-blocking strip can be placed between the object and the wall. The design of the closed protrusions continuously distributed on the surface of the water-blocking strip is such that even a small force is applied, an object to be installed can be closely fitted to a wall surface and no gap is prone to be formed therebetween, thereby achieving a better waterproofing and water-blocking effect.

Here, the terms “upper”, “lower”, “left”, “right”, “front”, and “rear” only represent their relative positions but not their absolute positions. The above are only examples of the present application, and therefore do not limit the scope of patent protection of the present application. The equivalent structure or equivalent process transformation made by the description and the drawings, or directly or indirectly used in other related technical fields, shall fall within the scope of protection of the present application.

What is claimed is:

1. A water-blocking strip for surface fitting installation,
the water-blocking strip comprising: a strip-shaped main body; and closed protrusions continuously distributed on a surface of the strip-shaped main body, so that installation is tightly fitted and water-blocking.

2. The water-blocking strip for surface fitting installation according to claim 1, wherein
each of the closed protrusions has a circular, polygonal or irregular closed shape, all the closed protrusions are closely arranged, and adjacent closed protrusions are in contact with each other or sharing a common edge.

3. The water-blocking strip for surface fitting installation according to claim 2, wherein
the closed protrusions themselves have lines with a line width of 0.3-10 mm, and a short cross-section of the lines is not pointed, the closed protrusions have a protruded height that is 10-300% of the line width.

4. The water-blocking strip for surface fitting installation according to claim 2, wherein
the closed protrusions are distributed at a certain angle on the surface of the strip-shaped main body, and the angle is not less than 15 degrees and not more than 165 degrees.

5. The water-blocking strip for surface fitting installation according to claim 3, wherein
the closed protrusions are distributed at a certain angle on the surface of the strip-shaped main body, and the angle is not less than 15 degrees and not more than 165 degrees.

6. The water-blocking strip for surface fitting installation according to claim 4, wherein
the closed protrusions are vertically distributed on the surface of the strip-shaped main body.

7. The water-blocking strip for surface fitting installation according to claim 5, wherein
the closed protrusions are vertically distributed on the surface of the strip-shaped main body.

8. The water-blocking strip for surface fitting installation according to claim 1, wherein
a material of the water-blocking strip itself is an elastic material.

9. The water-blocking strip for surface fitting installation according to claim 2, wherein
a material of the water-blocking strip itself is an elastic material.

10. The water-blocking strip for surface fitting installation according to claim 3, wherein
a material of the water-blocking strip itself is an elastic material.

11. The water-blocking strip for surface fitting installation according to claim 6, wherein
a material of the water-blocking strip itself is an elastic material.

12. The water-blocking strip for surface fitting installation according to claim 7, wherein
a material of the water-blocking strip itself is an elastic material.

13. The water-blocking strip for surface fitting installation according to claim 8, wherein
the material of the water-blocking strip itself is EVA, rubber, silicone, polyurethane or foam.

14. The water-blocking strip for surface fitting installation according to claim 9, wherein
the material of the water-blocking strip itself is EVA, rubber, silicone, polyurethane or foam.

15. The water-blocking strip for surface fitting installation according to claim 8, wherein
the closed protrusions are distributed on one surface of the strip-shaped main body.

16. The water-blocking strip for surface fitting installation according to claim 9, wherein
the closed protrusions are distributed on one surface of the strip-shaped main body.

17. The water-blocking strip for surface fitting installation according to claim 15, wherein
the closed protrusions are distributed on another surface of the strip-shaped main body.

18. The water-blocking strip for surface fitting installation according to claim 16, wherein
the closed protrusions are distributed on another surface of the strip-shaped main body.

19. The water-blocking strip for surface fitting installation according to claim 15, wherein
another surface of the strip-shaped main body is provided with an adhesive layer and forms a pasting surface.

20. The water-blocking strip for surface fitting installation according to claim 16, wherein
another surface of the strip-shaped main body is provided with an adhesive layer and forms a pasting surface.
